(19) United States
(12) Patent Application Publication
(10) Pub. No.: US 2011/0184102 A1
(43) Pub. Date: Jul. 28, 2011

(54) FLAME RETARDANT POLYCARBONATE RESIN COMPOSITION HAVING HIGH INFRARED TRANSMISSION

(75) Inventors: Bo Ri Kim, Jinhae (KR); Kyung Mo Park, Daejeon (KR); Sun Woo Hwang, Daejeon (KR); Sung Tae Ahn, Daejeon (KR)

(73) Assignee: LG CHEM, LTD., Seoul (KR)

(21) Appl. No.: 12/866,440

(22) PCT Filed: Dec. 5, 2008
(86) PCT No.: PCT/KR08/07229

§ 371 Date: Mar. 18, 2011

(30) Foreign Application Priority Data
Dec. 5, 2007 (KR) 10-2007-0125402
Dec. 5, 2008 (KR) 10-2008-0122868

(51) Int. Cl. C08K 5/52

(52) U.S. Cl. 524/127

(57) ABSTRACT

Provided is a thermoplastic polycarbonate resin composition. The resin composition contains (A) 83 to 93% by weight of a polycarbonate resin, (B) 6 to 17% by weight of aromatic phosphate, and (C) 0.08 to 0.3% by weight of fluoroolefin. The resin composition exhibits excellent infrared transmissivity and flame retardancy.

### TECHNICAL FIELD

The present invention relates to a non-halogen flame retardant polycarbonate resin composition having excellent infrared transmissivity and non-halogen flame retardancy imparted by incorporating a mixture of aromatic phosphate as a non-halogen flame retardant and fluoroolefin into a polycarbonate resin.

### BACKGROUND ART

In general, a polycarbonate resin per se has high infrared transmissivity. However, addition of aromatic phosphate and fluoroolefin, which are typically used to impart flame retardancy necessary for an external ornament of electric/electronic products, results in rapid deterioration of infrared transmissivity of the product. This approach has low infrared transmissivity, thus suffering from limitations of application thereof to products requiring infrared remote control operation, such as TV front cabinet and the like.

### DISCLOSURE OF INVENTION

### Technical Problem

Therefore, the present invention has been made in view of the above problems, and it is an object of the present invention to provide a flame retardant polycarbonate resin composition having excellent infrared transmissivity, by using non-halogen aromatic phosphate having excellent compatibility with a polycarbonate resin and thus causing no deterioration of infrared transmissivity even when a given amount of the non-ha logen aromatic phosphate is mixed with the polycarbonate resin and by using fluoroolefin having excellent dispersibility.

### Technical Solution

In accordance with an aspect of the present invention, the above and other objects can be accomplished by the provision of a flame retardant thermoplastic resin composition comprising (A) 83 to 93% by weight of a polycarbonate resin, (B) 6 to 17% by weight of aromatic phosphate, and (C) 0.08 to 0.3% by weight of fluoroolefin.

The polycarbonate resin is a compound prepared by reacting a divalent phenolic compound with a phosgene or carbonic acid diester and containing no halogen.

Further, the aromatic phosphate is a non-halogen flame retardant and is selected from aromatic monophosphate, aromatic diphosphate and a mixture thereof.

The aromatic monophosphate is preferably selected from the group consisting of non-halogen substituted triarylphosphate and trialkyl-arylphosphate.

Particularly, the triarylphosphate is selected from the group consisting of triphenylphosphate, tricresylphosphate, trixylenylphosphate and cresyldiphenylphosphate, and the trialkyl-arylphosphate is preferably octyldiphenylphosphate.

The aromatic diphosphate is preferably a compound represented by Formula 1:

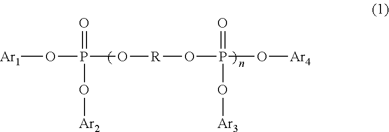

wherein Ar₁ to Ar₄ are each independently phenyl or aryl substituted with one to three C₁-C₄ alkyl, R is phenyl or bisphenol A, and 1≦n≦2.

Meanwhile, the fluoroolefin is preferably selected from fluorinated polyethylene, and fluoroethylene with attachment of a thermoplastic resin or organic material. Examples of the thermoplastic resin or organic material-bound fluoroethylene may include compounds having a core-shell structure where the core is fluoroethylene and the shell is a thermoplastic resin or organic material, and compounds having fluoroethylene with partial branching of a thermoplastic polymer or organic material. When the fluoroethylene compound is a compound having partial attachment of a thermoplastic polymer or organic material to fluoroethylene or is a core-shell type compound, superior dispersibility is obtained as compared to use of fluoroethylene alone. To fluoroethylene is largely attached a styrene organic material or a thermoplastic polymer partially containing a styrene-based moiety, or an acrylic organic material or a thermoplastic polymer partially containing an acrylic moiety.

In particular, the fluoroethylene is preferably polytetrafluorethylene (PTFE).

Examples of conventional additives that can be added to the resin composition of the present invention may include an antioxidant, a weathering stabilizer, a lubricant, a silicon supplement, a release agent, a pigment, a dye, an antistatic agent, an antibacterial agent, a processing aid, and antiabrasive. These additives can be used within a proper content.

As well known in the related art, mixing of composition components may be carried out by a conventional method involving dry blending of the components, followed by heating and melt-mixing. The mixing process is carried out typically at a temperature of 240° C. to 300° C., preferably 260° C. to 270° C., such that the individual components can sufficiently maintain physicochemical affinity therebetween. The resulting composition may be subjected to a molding method such as injection molding, extrusion molding, blow molding, or the like, which is conventionally employed in molding of polycarbonate.

### ADVANTAGEOUS EFFECTS

The present invention provides a polycarbonate resin composition with superior infrared transmissivity and flame retardancy. Therefore, the resin composition of the present invention can be used for applications of non-coated external parts of electric/electronic appliances to which an infrared controller is applied.

### MODE FOR THE INVENTION

Measurements of various physical properties in the following Examples and

Comparative Example are carried out as follows.

(1) Melt Flow Index (MFI)

MFI was measured at 300° C. and a load of 1.2 kg, according to ASTM D1238.

(2) Tensile Strength

The tensile strength was measured according to ASTM D-638.

(3) Flexural Strength

The flexural strength was measured according to ASTM D790.

(4) Flexural Modulus

The flexural modulus was measured according to ASTM D790.

(5) Izod Impact Strength

The Izod impact strength was measured at room temperature (23° C.) according to ASTM D256.

(6) Infrared Transmissivity

An injection-molded specimen having a diameter of 50 mm and a thickness 2 mm was prepared and attached to the receiver module of a conventional infrared controller. Then, a controllable distance was determined. The standard of a remote control test for a TV should exhibit a distance of more than 12 m for both the front and side.

(7) Flame Retardancy

The flame retardancy was measured using a specimen having a thickness of 1.6 mm, according to UL-94.

### Example 1

92.92% by weight of polycarbonate (PC) having a melt index of 10 g/10 min (ASTM D1238, 300° C., 1.2 kgf), 7% by weight of aromatic phosphate [Bis(diphenyl phosphate)], and 0.08% by weight of fluoroolefin [Acrylic modified PTFE] were melt-mixed and pelletized at 280° C. to obtain a resin composition. The resulting resin composition was molded into a specimen using an injection molding machine and physical properties of the specimen were measured according to the above specified methods. The results are given in Table 1 below.

### Example 2

A specimen was prepared and tested in the same manner as in Example 1, except that 87.92% by weight of PC, 12% by weight of aromatic phosphate, and 0.08% by weight of fluoroolefin were used. The results are given in Table 1 below.

### Example 3

A specimen was prepared and tested in the same manner as in Example 1, except that 82.92% by weight of PC, 17% by weight of aromatic phosphate, and 0.08% by weight of fluoroolefin were used. The results are given in Table 1 below.

### Example 4

A specimen was prepared and tested in the same manner as in Example 1, except that 92.7% by weight of PC, 7% by weight of aromatic phosphate, and 0.3% by weight of fluoroolefin were used. The results are given in Table 1 below.

### Example 5

A specimen was prepared and tested in the same manner as in Example 1, except that 87.7% by weight of PC, 12% by weight of aromatic phosphate, and 0.3% by weight of fluoroolefin were used. The results are given in Table 1 below.

### Example 6

A specimen was prepared and tested in the same manner as in Example 1, except that 82.7% by weight of PC, 17% by weight of aromatic phosphate, and 0.3% by weight of fluoroolefin were used. The results are given in Table 1 below.

### Comparative Example 1

% by weight of polycarbonate (PC) having a melt index of 10 g/10 min (ASTM D1238, 300° C., 1.2 kgf), 20% by weight of aromatic phosphate [Bis(diphenyl phosphate)], and 0.2% by weight of fluoroolefin were melt-mixed and pelletized at 260° C. to obtain a resin composition. The resulting resin composition was molded into a specimen using an injection molding machine and physical properties of the specimen were measured according to the above specified methods. The results are given in Table 1 below.

### Comparative Example 2

A specimen was prepared and tested in the same manner as in Comparative Example 1, except that 94.8% by weight of PC, 5% by weight of aromatic phosphate, and 0.3% by weight of fluoroolefin were melt-mixed and pelletized at 280° C. to obtain a resin composition. The results are given in Table 1 below.

### Comparative Example 3

A specimen was prepared and tested in the same manner as in Comparative Example 1, except that 87.6% by weight of PC, 12% by weight of aromatic phosphate, and 0.4% by weight of fluoroolefin were used. The results are given in Table 1 below.

TABLE 1

| | | Example No. | | | | | | Comparative Example No. | | |
|---|---|---|---|---|---|---|---|---|---|---|
| | | 1 | 2 | 3 | 4 | 5 | 6 | 1 | 2 | 3 |
| Composition | Polycarbonate | 92.92 | 87.92 | 82.92 | 92.7 | 87.7 | 82.7 | 87.8 | 94.8 | 87.6 |
| | Aromatic | 7 | 12 | 17 | 7 | 12 | 17 | 20 | 5 | 12 |
| | phosphate | | | | | | | | | |
| | Fluoroolefin | 0.08 | 0.08 | 0.08 | 0.3 | 0.3 | 0.3 | 0.2 | 0.3 | 0.4 |
| Physical | MFI | 34 | 38 | 40 | 28 | 33 | 36 | 41 | 28 | 30 |
| properties | Tensile strength | 733 | 736 | 740 | 731 | 737 | 741 | 746 | 700 | 735 |
| | Flexural | 1185 | 1190 | 1210 | 1180 | 1189 | 1206 | 1220 | 970 | 1180 |
| | strength (⅛″) | | | | | | | | | |
| | Flexural | 27500 | 27500 | 27800 | 27300 | 27400 | 27750 | 27800 | 24000 | 27300 |
| | modulus (⅛″) | | | | | | | | | |
| | Izod impact | 4.6 | 3.9 | 3.3 | 4.5 | 4.0 | 3.3 | 3 | 10.0 | 4.3 |
| | strength (⅛″) | | | | | | | | | |
| | Infrared | More | More | More | 12 m | 12 m | 12 m | 1 m | 12 m | 4 m |
| | transmissivity | than | than | than | | | | | | |
| | | 18 m | 18 m | 18 m | | | | | | |
| | Flame | V-0 | V-0 | V-0 | V-0 | V-0 | V-0 | V-2 | V-1 | V-0 |
| | retardancy | | | | | | | | | |

As can be seen from the results of Table 1, polymer compositions of Examples 1 to 6 and Comparative Examples 1 to 3 exhibited differences in the infrared transmissivity and flame retardancy, depending on varying contents of aromatic phosphate and fluoroolefin.

Both of aromatic phosphate and fluoroolefin are used as flame retardant aids. Aromatic phosphate exhibits flame retardancy. That is, when it is combusted, the aromatic phosphate produces polymetaphosphate by pyrolysis and the resulting polymetaphosphate forms a protective layer on a resin, thereby providing flame retardancy. Fluoroolefin is added to prevent the occurrence of dripping upon combustion of the resin. Higher contents of the aromatic phosphate and fluoroolefin provide higher flame retardancy.

However, in order to secure high flame retardancy and high infrared transmissivity in the resin of interest, contents of aromatic phosphate and fluoroolefin are limited.

Particularly, the content of fluoroolefin exhibits the most significant effects on the infrared transmissivity and flame retardancy.

Only when the content of fluoroolefin was 0.08% by weight or higher, dripping did not occur in a UL 94 test, thus satisfying V-0. When the content of fluoroolefin was lower than 0.08% by weight, fluoroolefin did not exert a sufficient role as a dripping inhibitor, which resulted in the occurrence of dripping, leading to V-2.

When the content of fluoroolefin was 0.3% by weight or higher, the composition was visually observed to turn opaque, resulting in rapid deterioration of the infrared transmissivity.

As preferred effects, physical properties of the resin composition of the present invention maintain high infrared transmissivity and flame retardancy V-0. It can be seen from Examples 1 to 3 that the resin composition of the present invention exhibiting these effects is a composition containing 6 to 17% by weight of aromatic phosphate and 0.08 to 0.3% by weight of fluoroolefin.

Therefore, it is apparent that infrared transmissivity and flame retardancy of the resin composition can be determined depending on contents of fluoroolefin and aromatic phosphate exhibiting high compatibility with the polycarbonate resin.

1. A flame retardant thermoplastic resin composition comprising (A) a polycarbonate resin, (B) aromatic phosphate, and (C) fluoroolefin.

2. The composition according to claim 1, wherein the composition contains (A) 83 to 93% by weight of the polycarbonate resin, (B) 6 to 17% by weight of the aromatic phosphate, and (C) 0.08 to 0.3% by weight of the fluoroolefin.

3. The composition according to claim 1, wherein the polycarbonate resin is a compound prepared by reacting a divalent phenolic compound with a phosgene or carbonic acid diester and containing no halogen.

4. The composition according to claim 1, wherein the aromatic phosphate is selected from aromatic monophosphate, aromatic diphosphate and a mixture thereof.

5. The composition according to claim 4, wherein the aromatic monophosphate is selected from the group consisting of non-halogen substituted triarylphosphate and trialkyl-arylphosphate.

6. The composition according to claim 5, wherein the triarylphosphate is selected from the group consisting of triphenylphosphate, tricresylphosphate, trixylenylphosphate and cresyldiphenylphosphate, and the trialkyl-arylphosphate is octyldiphenylphosphate.

7. The composition according to claim 4, wherein the aromatic diphosphate is a compound represented by Formula 1: 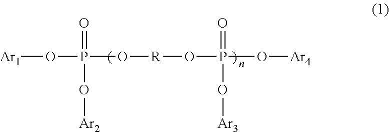
wherein Ar₁ to Ar₁ are each independently phenyl or aryl substituted with one to three C₁-C₄ alkyl, R is phenyl or bisphenol A, and 1≦n≦2.

8. The composition according to claim 1, wherein the fluoroolefin is selected from fluorinated polyethylene and organic material or thermoplastic resin-bound fluorinated polyethylene.

9. The composition according to claim 8, wherein the fluorinated polyethylene is polytetrafluorethylene.

10. The composition according to claim 1, further comprising at least one selected from the group consisting of a lubricant, a heat stabilizer, a light stabilizer, a dripping inhibitor, a pigment and a dye, and an inorganic filler.

11. The composition according to claim 2, wherein the polycarbonate resin is a compound prepared by reacting a divalent phenolic compound with a phosgene or carbonic acid diester and containing no halogen.

12. The composition according to claim 2, wherein the aromatic phosphate is selected from aromatic monophosphate, aromatic diphosphate and a mixture thereof.

13. The composition according to claim 2, wherein the fluoroolefin is selected from fluorinated polyethylene and organic material or thermoplastic resin-bound fluorinated polyethylene.

14. The composition according to claim 2, further comprising at least one selected from the group consisting of a lubricant, a heat stabilizer, a light stabilizer, a dripping inhibitor, a pigment and a dye, and an inorganic filler.
